(19) United States
(12) Patent Application Publication
(10) Pub. No.: US 2006/0284399 A1
(43) Pub. Date: Dec. 21, 2006

(54) Ball mount

(76) Inventors: Frank Scott, Milwaukee, WI (US); Mike Sheridan, Lake Villa, IL (US); John Weber, Thiensville, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(21) Appl. No.: 11/455,448

(22) Filed: Jun. 19, 2006

Related U.S. Application Data
(60) Provisional application No. 60/691,611, filed on Jun. 17, 2005.

(51) Int. Cl. B60D 1/06

(52) U.S. Cl. 280/511

(57) ABSTRACT

A customizable towing hitch ball mount arrangement is provided for assembly with a hitch receiver on a vehicle. The arrangement includes a ball mount and a customizing element. The ball mount has a proximal end for insertion into an opening in the hitch receiver, an elongated tube portion, a drop portion extending from the elongated tube portion and angled with respect to a length of the elongated tube portion, and a plate extending substantially horizontally from the drop portion. The plate has an aperture for attachment of a hitch ball. The customizing element has at least one keying feature, wherein the customizing element is removably attachable to the ball mount by aligning the keying feature with a corresponding mounting surface on the drop portion of the ball mount.

### CROSS REFERENCE TO RELATED APPLICATIONS

This application claims the benefit of U.S. Provisional Patent Application No. 60/691,611, filed Jun. 17, 2005, the entire disclosure of which is hereby incorporated by reference.

### FIELD OF THE INVENTION

The present invention relates to ball mounts for use in pulling trailers.

### BACKGROUND OF THE INVENTION

The device used to attach a towing hitch ball to a vehicle is generally referred to in the art as a ball mount, as shown, for example, in FIGS. 1A, 1B, and 1C. These devices fit into a hitch receiver which is permanently mounted to the center rear of the vehicle. Ball mounts usually contain an elongated tube for insertion into the hitch receiver and a flat horizontal area for the hitch ball to sit. When not is use, ball mounts may be removed from the vehicle at the discretion of the vehicle operator.

Plugs which cover the opening in the hitch receiver when the ball mount is not installed are available with a wide range of cosmetic options like sports team logos, vehicle brand logos, etc., as shown, for example, in FIGS. 2A, 2B, and 2C. However, these popular plugs can only be used when the ball mount is removed.

To satisfy a demand for ball mounts that include a cosmetic element, ball mounts with logos or other ornamentation have been developed. Ball mounts are typically made by an investment cast process, or similar process, which requires unique molds for each ball mount having a new cosmetic element. A new wax mold for investment casting needs to be made for every new logo or configuration with the existing design. Each new cosmetic design must be re-tested in case the cosmetic features cause a change in the manufacturing process that affect the strength. Each test must also be repeated for each available ball mount size (e.g., 2″ drop, 4″ drop, etc.). Certified testing is expensive and time consuming. Further, cast ball mounts typically have their surfaces polished or sand blasted after casting to give an acceptable surface finish. This process can be very time consuming due to the detail of the cosmetic elements and the polishing process can basically wipe away features making them less defined. Additionally, some cosmetic features/finishes cannot be produced by the casting process.

### SUMMARY OF THE INVENTION

According to an aspect of the present application, a separate customizing element may be attached to a ball mount. In one embodiment, a customizable towing hitch ball mount arrangement is provided for assembly with a hitch receiver on a vehicle. The arrangement includes a ball mount and a customizing element. The ball mount has a proximal end for insertion into an opening in the hitch receiver, an elongated tube portion, a drop portion extending from the elongated tube portion and angled with respect to a length of the elongated tube portion, and a plate extending substantially horizontally from the drop portion. The plate has an aperture for attachment of a hitch ball. The customizing element has at least one keying feature, wherein the customizing element is removably attachable to the ball mount by aligning the keying feature with a corresponding mounting surface on the drop portion of the ball mount.

### BRIEF DESCRIPTION OF THE DRAWINGS

Further features and advantages of the invention will become apparent from the following detailed description made with reference to the accompanying drawings, wherein:

FIGS. 1A, 1B, and 1C are perspective views of various conventional ball mounts;

FIGS. 2A, 2B, and 2C are perspective views of various conventional trailer hitch plugs;

FIG. 3 is an exploded perspective views of a trailer hitch ball mount arrangement;

FIG. 4 is a rear perspective view of the ball mount arrangement of FIG. 3;

FIG. 5 is an exploded side perspective view of a trailer hitch ball mount arrangement; and

FIG. 6 is a front perspective view of a ball mount.

### DETAILED DESCRIPTION OF THE INVENTION

The Detailed Description of the Invention merely describes preferred embodiments of the invention and is not intended to limit the scope of the claims in any way. Indeed, the invention as described by the claims is broader than and unlimited by the preferred embodiments, and the terms in the claims have their full ordinary meaning.

The present invention provides a customizable towing hitch ball mount for assembly with a hitch receiver on a vehicle. The invention provides a ball mount that is adapted to have any one or more of a variety of customizing elements removably attached to the ball mount, thereby separating the cosmetic or auxiliary features of the ball mount from the towing aspect. This separation can reduce costs of certified testing of investment cast ball mounts, simplify surface polishing and sand blasting operations on the ball mount, and allow for more versatile customization of the ball mount, which may otherwise be limited by the investment casting process. The various embodiments of the invention offer other specific improvements over prior art cast ball mounts.

The embodiments of the present ball mount offer increased flexibility and reduced manufacturing costs by including several novel design features. In one embodiment, the ball mount may include a separate mounting area for a cosmetic element. Therefore, the cosmetic element can be switched at the discretion of the vehicle operator. Further, the cosmetic element can be made by alternative manufacturing processes, in lower quantities, and in shorter lead times than available by investment casting. One cosmetic element can be used on a variety of ball mount configurations, such as for example, 2″, 4″ and 6″ drop configurations.

The device may provide options for attaching cosmetic or other elements to a towing ball mount. The device may improve operator options, device appearance, and manufacturability over known devices by making the cosmetic elements separable from the functional aspects of the ball mount.

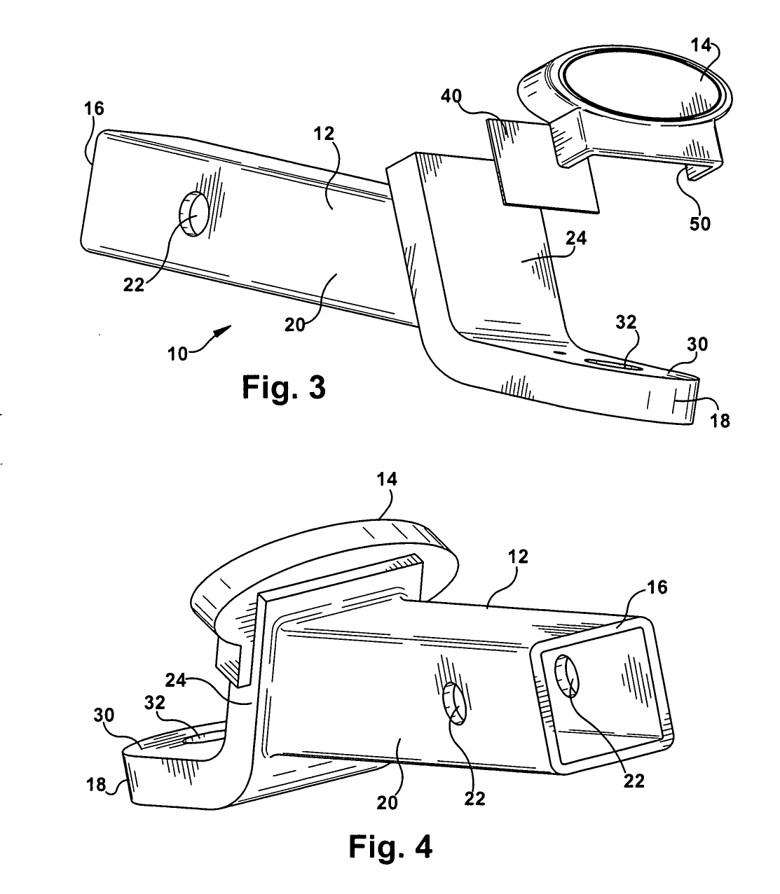

In an embodiment of the present invention shown in FIGS. 3 and 4, a ball mount device 10 includes a ball mount 12 and a customizing element 14. While the customizing element 14 may include an ornamental logo or display, as shown in FIG. 3, the customizing element may provide other useful features, such as, for example, light sources, visual indicators, or covering, locking, or attachment means, as discussed more fully below. The device 10 is installable into the hitch receiver (not shown) of a conventional vehicle, such as, for example, a pickup truck or an SUV. When not in use for pulling a trailer or other object, the device 10, with or without the customizing element 14, can remain installed and provide cosmetic appeal or functional utility.

The ball mount 12 includes a proximal end 16 in relation to a vehicle (not shown) and a distal end 18. The proximal end 16 is adapted to be inserted into a hitch receiver of a vehicle. An elongated tube section 20 of the ball mount defines two opposing apertures 22. By using these apertures 22, a pin or locking device (not shown) is used to mount or attach the ball mount 12 to the hitch receiver. The ball mount 12 further includes an angled planar area 24. This area is commonly referred to in the art as a drop 24. The ball mount also includes a flat horizontal area or plate 30 that defines an aperture 32 for insertion of a hitch ball (not shown).

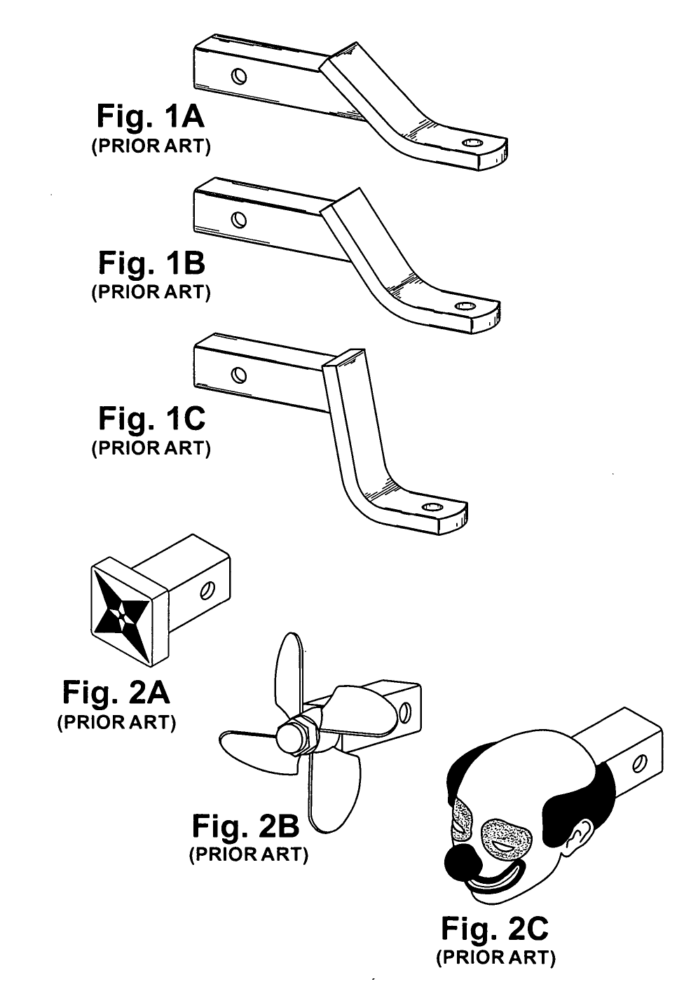

For example only, FIGS. 1A, 1B, and 1C are perspective views of various conventional ball mounts. The ball mount 12 of the present invention can be manufactured by investment ball casting as shown, or by any other suitable method such as a common welded design used with a mounting feature drilled or machined into the angled plate that is welded onto the tube.

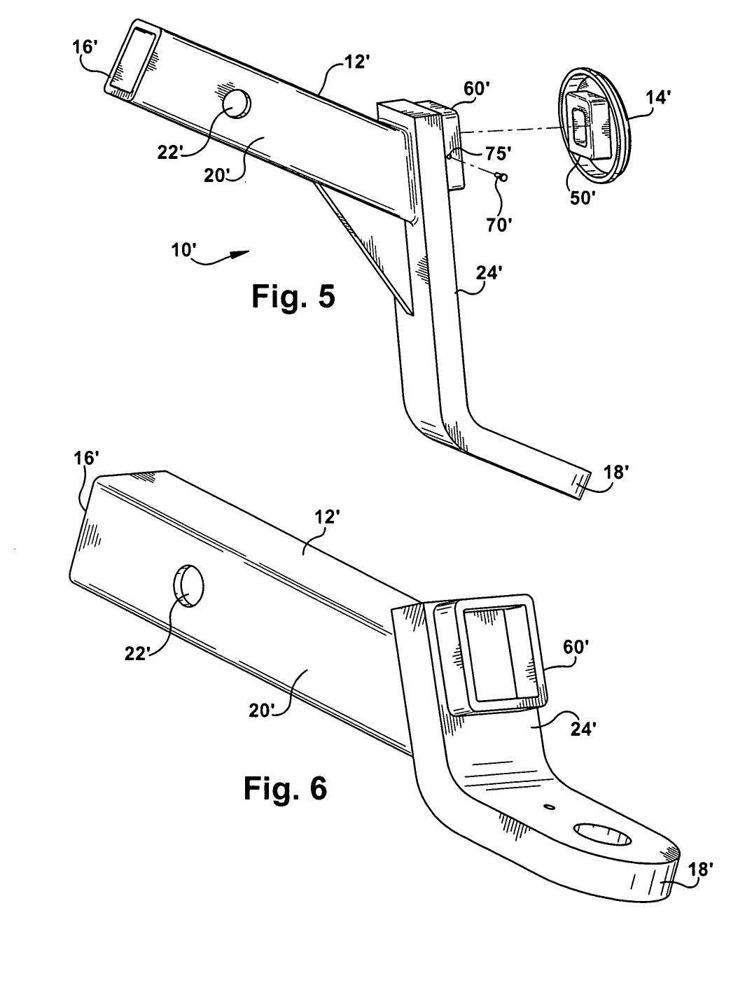

The ball mounts 12, 12′ of FIGS. 3, 4, and 6 have a drop/rise configuration of approximately 2 inches, as measured vertically from the upper surface of the elongated tube 12 to the upper surface of the plate 30. The ball mount 12′ of FIG. 5 has a drop/rise of approximately 8″. However, it should be understood by those with ordinary skill in the art that the present invention is applicable to a variety of configurations, including, for example, drop/rise configurations of 4 and 6 inches. Regardless of the dimension of the drop 24, the drop 24 may provide an at least partially vertical surface, such as, for example, the angled planar surface shown in FIGS. 3 and 6, from which a customizing element 14 may be displayed.

To allow for the attachment of a customizing element 14 to the ball mount 12, one or more keying features may be provided on the customizing element for engagement with a corresponding mounting surface on the ball mount 12, such as on the drop portion 24. In one embodiment, the keying feature is adapted and dimensioned to engage the drop portion of a conventional ball mount, such as the ball mounts shown in FIGS. 1A, 1B, and 1C. In the illustrated embodiment of FIGS. 3 and 4, the keying feature includes a recess or cut-out 50 provided on a rear side of the customizing element 14. As shown, the recess 50 may be complementary shaped with respect to the drop portion 24, such that the customizing element 14 is properly aligned on the drop portion 24 when installed.

Many different mechanisms or methods may be used to attach or affix the customizing element 14 to the ball mount 12. In one embodiment, the mounting surface and the keying feature may be dimensioned for a press-fit engagement. In another embodiment, a fastener may be used to attach the customizing element to the ball mount, for example, a screw and nut combination. In the illustrated embodiment of FIG. 3, an adhesive 40, such as, for example, two-sided structural adhesive tape, may be placed between the keying feature 50 and the drop portion 24.

In another embodiment, a mounting surface of the ball mount may be provided on one or more locating features disposed on a surface of the ball mount, such as, for example, on the angled planar surface of the drop portion. Many different locating features may be provided for engagement with a keying feature on a customizing element. In one embodiment, the locating feature includes a protrusion extending from the planar surface of the drop portion. The protrusion may be sized or configured to mate with a corresponding keying feature on the customizing element, such as a recess or another protrusion. For example, the locating feature may include a tubular extension sized to receive a protrusion extending from a rear side of the customizing element. Further, the corresponding keying feature and locating feature may be shaped such that the locating feature prevents transverse movement, such as sliding or rotation, of the customizing element on the ball mount, to facilitate proper alignment of the customizing element during and/or after assembly.

In the illustrated examples of FIGS. 5 and 6, a square tube stub 60′ is welded to the drop portion 24′ of the ball mount 12′, providing a locating feature or recess into which a keying feature 50′ of the customizing element 14′ may be received. The exemplary keying feature 50′ is a complementary shaped boss or protrusion sized to provide proper alignment of the customizing feature on the ball mount. While many mechanisms or methods may be used to affix the customizing element 14′ to the locating feature 60′, such as, for example, an adhesive or a press fit engagement, the illustrated embodiment uses a fastener 70′, such as a pin or screw, inserted through a mounting hole 75′ in the locating feature 60′, to secure the customizing element 14′ within the locating feature 60′. Such an arrangement may or may not require a corresponding mounting hole (not shown) in the keying feature 50′. The complementary square shapes of the locating feature 60′ and keying feature 50′ prevent rotational and sliding movement of the customizing element 14′ during and after assembly to provide proper alignment of the customizing element 14′ on the ball mount 12′.

In the exemplary embodiments, the customizing element may include a logo or indicia associated with a recognizable commercial brand, sports team, trademark etc. A variety of other indicia can be used in the practice of the present invention. For example only, FIGS. 2A, 2B, and 2C include perspective views of various conventional trailer hitch plugs that include other cosmetic designs. However, it should be noted that the customizing element need not be limited to cosmetic properties, and in some embodiments, may provide functional utility instead of, or in addition to, cosmetic features. Other elements that could be installed to the ball mount include, for example only: all or part of a trailer locking mechanism to secure the coupler on the hitch ball during use; a work light or back-up light, either connected to the vehicle power system or battery operated; a visual device to help with alignment to the trailer coupler while backing up the vehicle; a mechanical device to help with the alignment of the vehicle and trailer coupler; a foot step, either folding or side location; or a storage box for towing supplies. As another example, the customizing element may include a hinged and/or removable flip-up hitch cover, which may cover the entire hitch ball and most of the exposed ball mount when not towing to reduce exposure to the elements. The cover could also be padded internally or externally to soften the blow when someone walks into the protruding ball mount. The exterior of the cover could have a location for cosmetic elements and eliminate the issue of the cosmetics being hard to see on the ball mount with the hitch ball in place. In alternative embodiments of the invention, multiple customizing elements may be attachable to the ball mount.

The customizing element may be produced by a variety of methods, which may be either the same as (such as investment casting) or different than the methods used to produce the ball mount. This flexibility is one of the advantages of the separation of the towing and accessory elements. For example, the customizing element may include parts made by aluminum or zinc die casting, plastic injection molding, stamping or forging.

While several embodiments of the invention has been illustrated and described in considerable detail, the present invention is not to be considered limited to the precise constructions disclosed. Various adaptations, modifications and uses of the invention may occur to those skilled in the arts to which the invention relates. It is the intention to cover all such adaptations, modifications and uses falling within the scope or spirit of the claims filed herewith.

What is claimed is:

1. A ball mount for assembly with a hitch receiver on a vehicle, the ball mount comprising:
an elongated tube portion having a circumferential side wall, a proximal end for insertion into an opening in the hitch receiver, and a pair of opposing apertures disposed in the side wall for mounting the ball mount to the hitch receiver;
a drop portion, extending from the elongated tube portion and angled with respect to a length of the elongated tube portion, the drop portion having a planar area facing away from the proximal end and at least one locating feature disposed on the planar area for engaging a corresponding keying feature of a customizing element; and
a plate, extending substantially horizontally from the drop portion, the plate having an aperture for attachment of a hitch ball.

2. The ball mount of claim 1, wherein the locating feature comprises a protrusion extending from the planar surface.

3. The ball mount of claim 2, wherein the protrusion comprises a tubular extension adapted to receive a corresponding protrusion on a customizing element.

4. The ball mount of claim 3, wherein the tubular extension comprises a section of tube welded to the planar surface.

5. The ball mount of claim 4, wherein the section of tube comprises square tube.

6. The ball mount of claim 1, wherein a vertical distance between an upper surface of the elongated tube portion and an upper surface of the plate is approximately two inches.

7. The ball mount of claim 1, wherein the locating feature comprises a mounting hole for affixing the locating feature to the keying feature with a fastener.

8. A customizable towing hitch ball mount arrangement for assembly with a hitch receiver on a vehicle, the arrangement comprising:
a ball mount having a proximal end for insertion into an opening in the hitch receiver; an elongated tube portion; a drop portion, extending from the elongated tube portion and angled with respect to a length of the elongated tube portion; and a plate extending substantially horizontally from the drop portion, the plate having an aperture for attachment of a hitch ball; and
a customizing element having at least one keying feature, wherein the customizing element is removably attachable to the ball mount by aligning the keying feature with a corresponding mounting surface on the drop portion of the ball mount.

9. The arrangement of claim 8, wherein the keying feature comprises a recess shaped to receive the drop portion mounting surface.

10. The arrangement of claim 8, wherein the keying feature comprises a protrusion and the mounting surface comprises a complementary shaped tubular extension for receiving the protrusion.

11. The arrangement of claim 10, wherein the tubular extension comprises a section of tube welded to the planar surface.

12. The arrangement of claim 11, wherein the section of tube comprises square tube.

13. The arrangement of claim 8, wherein engagement of the keying feature with the mounting surface prevents transverse movement of the customizing element with respect to the drop portion of the ball mount.

14. The arrangement of claim 8, wherein the mounting surface and the keying feature comprise aligned mounting holes for affixing the locating feature to the keying feature with a fastener.

15. The arrangement of claim 8, wherein the keying feature is adapted to provide a press fit engagement with the mounting surface.

16. A method for manufacturing a customized towing hitch ball mount, the method comprising:
forming a ball mount having an elongated tube portion, a drop portion extending from the elongated tube portion, and a plate extending substantially horizontally from the drop portion;
providing a customizing element having a keying feature disposed on a rear side of the customizing element; and
attaching the customizing element to the ball mount by engaging the keying feature of the customizing element with a complementary shaped mounting surface on the drop portion of the ball mount.

17. The method of claim 16, wherein providing a customizing element having a keying feature disposed on a mounting surface of the customizing element comprises providing a recess in the customizing element into which the mounting surface may be received.

18. The method of claim 16, wherein the mounting surface comprises a tubular extension adapted to receive the keying feature.

19. The method of claim 16, further comprising providing a press fit between the keying feature and the mounting surface.

20. The method of claim 16, further comprising placing an adhesive between the keying feature and the mounting surface.
